(19) United States
(12) Patent Application Publication
(10) Pub. No.: US 2011/0209723 A1
(43) Pub. Date: Sep. 1, 2011

(54) Methods Of Treating Clothing And Textiles And Articles Treated Thereby

(76) Inventors: David Hunt Sullivan, Boynton Beach, FL (US); Richard Cipullo, Gainesville, FL (US)

(21) Appl. No.: 13/038,001

(22) Filed: Mar. 1, 2011

Related U.S. Application Data
(60) Provisional application No. 61/309,272, filed on Mar. 1, 2010.

(51) Int. Cl. D06B 1/00; B08B 7/02

(52) U.S. Cl. 134/1

(57) ABSTRACT

Articles such as clothing, textiles and accessories are exposed to selected frequencies from a frequency generator for selected periods of time. When the treated articles are worn or otherwise located in close proximity to a person or animal, they have been found to increase performance such as balance, flexibility, strength, endurance and focus, e.g., in workers, athletes, patients, and other types of people.

### CROSS-REFERENCE TO RELATED APPLICATION

This application claims the benefit of U.S. Provisional Patent Application Ser. No. 61/309,272 filed Mar. 1, 2010, which is incorporated herein by reference.

### FIELD OF THE INVENTION

The present invention relates to the treatment of articles such as clothing and textiles with selected frequencies.

### BACKGROUND INFORMATION

Many types of activities require balance, flexibility, endurance, strength and focus. It would be helpful to improve performance during such activities. For example, increased balance, flexibility, endurance, strength and focus would be helpful for workers, athletes, patients and many other people.

### SUMMARY OF THE INVENTION

The present invention provides articles such as clothing, textiles and accessories that have been subjected to at least one selected frequency. When the treated articles are worn by a person or animal, or otherwise located in close proximity to the person or animal, they have been found to increase performance.

An aspect of the present invention is to provide a method of treating articles comprising positioning the articles in proximity to a frequency generator, generating at least one selected frequency from the frequency generator, exposing the articles to the at least one selected frequency for a selected period of time, and recovering the articles after their exposure to the at least one selected frequency.

Another aspect of the present invention is to provide articles treated by the above-noted method.

These and other aspects of the present invention will be more apparent from the following description.

### BRIEF DESCRIPTION OF THE DRAWINGS

FIG. 1 is a schematic plan view illustrating the treatment of articles with a frequency generator in accordance with embodiments of the present invention.

FIG. 2 is a graph illustrating pre-test strength patterns for test subjects without the use of treated apparel.

FIG. 3 is a graph illustrating post-test strength patterns demonstrating increased strengths for test subjects using treated clothing in accordance with an embodiment of the present invention.

FIGS. 4 and 5 are graphs illustrating test results in accordance with an embodiment of the present invention.

FIG. 6 is a graph illustrating gait velocity improvements in test subjects in accordance with an embodiment of the present invention.

FIG. 7 is a graph illustrating walking endurance improvements in test subjects in accordance with an embodiment of the present invention.

FIG. 8 is illustrates improved test results for various physical activities for test subjects in accordance with an embodiment of the present invention.

### DETAILED DESCRIPTION

In accordance with embodiments of the present invention, articles such as clothing, textiles and accessories are treated with at least one selected frequency. The treated articles have been found to improve performance such as balance, flexibility, endurance, strength and focus when the articles are worn or used.

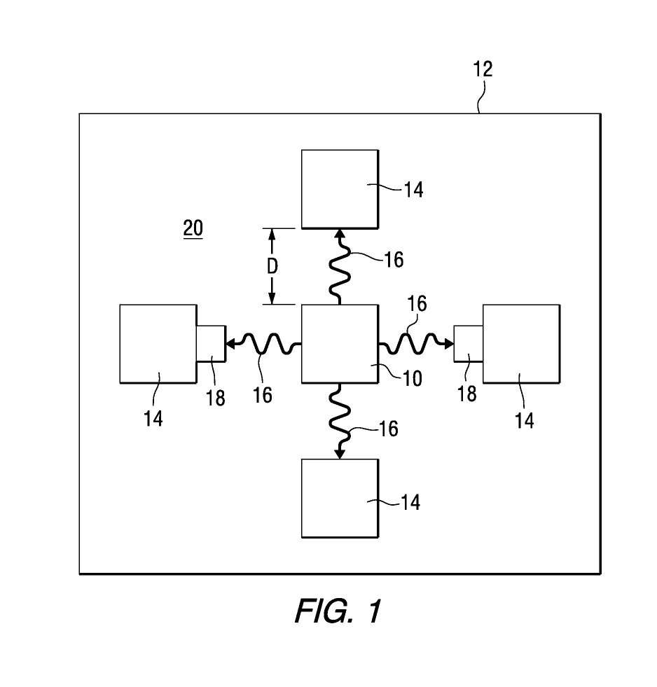

FIG. 1 schematically illustrates the treatment of articles with a frequency generator in accordance with embodiments of the present invention. A frequency generator 10 is located in a confined space 12 in proximity to multiple articles 14 to be treated. Electromagnetic radiation 16 having at least one selected frequency is directed from the frequency generator 10 toward the articles 14. As more fully described below, the frequency generator 10 may be in direct contact with the articles 14, or may be located a distance D away from the articles. In the embodiment shown in FIG. 1, a material 18 may be positioned between the frequency generator 10 and at least some of the articles 14. The material may be solid, liquid and/or gaseous, as more fully described below. The atmosphere 20 inside the container 12 may be gaseous, liquid and/or solid. For example, the atmosphere 20 may comprise air.

The articles 14 shown in FIG. 1 may comprise single articles or multiple articles. The article(s) may be exposed directly to the atmosphere 20 inside the container 12, or may be contained in or on packaging, boxes, bins, pallets, shelving and the like.

Suitable types of clothing that may be treated by the process include shirts (tee shirts, sweatshirts, hoodies, golf shirts, undershirts, vests, and the like), uniforms (sports uniforms, work uniforms, industrial uniforms, military uniforms, law enforcement uniforms, firefighter uniforms, EMT uniforms, medical uniforms, scrubs, nurse's uniforms, and the like), exercise apparel, sports apparel, recreational apparel, physical therapy apparel, sleepwear, pants, shorts, leggings, underwear, long underwear, undergarments, bras, jackets, gowns, aprons, bibs, outerwear, socks, hats, caps, helmets, shoes, boots, braces, sports pads, clothing accessories, In an embodiment of the present invention, the clothing articles comprise textiles such as woven and/or non-woven cloth.

In certain embodiments, an entire article of clothing is treated with the selected frequency(ies). In other embodiments, components or parts of an article of clothing may be treated. For example, labels, tags, logos, buttons, zippers, fibers, threads, and other clothing components may be treated prior to, during or after they are assembled into an article of clothing.

In addition to articles of clothing, other types of textiles may be treated by the present process, such as woven cloth, non-woven cloth, felt, matting, bedding, sheets, blankets, comforters, pillow cases, pillows, carpeting, rugs, window coverings, drapes, window shades, towels, washcloths, and the like. An entire textile article may be treated by the process, or individual components may be treated. For example, fibers or threads of a textile article may be treated before, during or after they are incorporated into a textile article.

The clothing and/or textiles may comprise natural fibers such as cotton, wool, silk, linen, fur, leather, hemp and the like, as well as man-made fibers such as polyester, polypropylene, rayon, nylon, Kevlar, spandex, and the like.

In certain embodiments of the invention, accessories to be worn or used by people or animals are treated with the selected frequency(ies). For example, accessories such as wrist bands, arm bands, head bands, leg bands, ankle bands, belts, watches, jewelry, bracelets, necklaces, earrings, pendants, pins, eyeglasses, cell phones, smart phones, PDAs, pet collars, and the like may be subjected to the treatment process.

Clothing, textiles and accessories treated by the process may be used by various people and animals for many different purposes. For example, uniforms or other types of clothing may be worn by industrial workers, healthcare workers, doctors, nurses, physical therapists, hospitality industry workers, construction workers, athletes, physical trainers, health club/gym members, exercisers, medical patients, sleep therapy patients, physical therapy patients, etc. The clothing may be worn for work, exercising, sports, recreation, sleep, leisure, medical treatment, military uses, police enforcement, fire rescue, EMT uses, baggage handlers, package handlers, etc. Such activities may be conducted indoors and/or outdoors with improved performance, e.g., under building or cloud cover, or in direct sunlight. In one embodiment, the articles are worn by humans, while in another embodiment, the articles are worn by animals (pets such as cats, dogs, horses, etc.).

In accordance with embodiments of the invention, the articles are treated by subjecting them to selected frequencies. Typical frequencies may range from 0.001 Hz and below to 100 MHz and above. For example, frequencies of from about 0.01 Hz to about 1,000 kHz may be used. In one embodiment, the frequencies are from about 0.1 Hz to about 100 kHz. The following Table 1 lists some of the specific frequencies that may be used.

TABLE 1
Frequencies (Hz)

| | | | | | | | | | | |
|---|---|---|---|---|---|---|---|---|---|---|
| 0.1 | 11 | 43 | 125 | 428 | 805.6 | 863.3 | 911 | 1314.6 | 2020 | 7090 |
| 0.2 | 12 | 43.65 | 130 | 436 | 807.23 | 864.62 | 912 | 1344.1 | 2025 | 8581 |
| 0.3 | 13 | 45 | 135 | 440 | 808.7 | 865.94 | 914 | 1373.7 | 2075 | 9000 |
| 0.4 | 14 | 45.94 | 146 | 442 | 810.35 | 867.25 | 915 | 1403.2 | 2128 | 9205 |
| 0.5 | 15 | 46 | 148 | 444 | 811.91 | 868.51 | 916 | 1432.7 | 2128 | 9627 |
| 0.6 | 15.05 | 47.5 | 160 | 450 | 815.04 | 869.77 | 917 | 1462.3 | 2150 | 9680 |
| 0.67 | 17 | 48 | 162 | 460 | 816.6 | 871.02 | 918 | 1491.8 | 2170 | 10000 |
| 0.75 | 17.25 | 49 | 163 | 465 | 818.16 | 872.28 | 919 | 1500 | 2190 | 10646 |
| 1 | 18 | 50 | 164 | 475 | 819.73 | 873.53 | 920 | 1510 | 2260 | 10961 |
| 1.1 | 20 | 51.68 | 165 | 478 | 821.29 | 874.79 | 921 | 1521.3 | 2489 | 11780 |
| 1.2 | 20 | 55 | 180 | 500 | 822.75 | 876.04 | 922 | 1550 | 2720 | 11862 |
| 1.5 | 20.75 | 56 | 190 | 505 | 824.22 | 877.3 | 924 | 1550.9 | 3040 | 11971 |
| 1.9 | 21 | 57 | 191.15 | 522 | 825.69 | 878.55 | 924 | 1570 | 3078 | 12025 |
| 2.1 | 21.34 | 60 | 192 | 528 | 827.16 | 880 | 925 | 1580.4 | 3084 | 12275 |
| 2.3 | 23 | 61 | 195 | 555 | 828.63 | 880 | 926 | 1590 | 3092 | 12921 |
| 2.4 | 24 | 62 | 200 | 589 | 830.1 | 881 | 927 | 1600 | 3097 | 13000 |
| 2.5 | 25 | 63 | 210 | 595 | 831.57 | 882 | 929 | 1604 | 3176 | 13225 |
| 2.65 | 26 | 64 | 220 | 600 | 832 | 883 | 930 | 1609.9 | 3200 | 13444 |
| 3 | 26.5 | 64.5 | 220.8 | 610 | 833.04 | 885 | 931 | 1639.5 | 3524 | 14824 |
| 3.5 | 27 | 66 | 230 | 625 | 834.51 | 886 | 960 | 1650 | 4185 | 15025 |
| 3.6 | 27.25 | 67 | 234 | 633 | 835.98 | 887 | 980 | 1669 | 4400 | 15876 |
| 3.9 | 27.5 | 69 | 240 | 640 | 837.46 | 888 | 980 | 1672 | 4500 | 16028 |
| 4.9 | 28 | 70 | 248 | 650 | 838.85 | 889 | 986 | 1698.5 | 4523 | 16868 |
| 5.8 | 28.75 | 71 | 250 | 660 | 840.24 | 891 | 990 | 1728.1 | 4765 | 17021 |
| 6 | 30.87 | 72 | 251 | 665 | 841.63 | 892 | 999 | 1757.6 | 4795 | 17776 |
| 6.3 | 31 | 73 | 260 | 672 | 843.02 | 893 | 999 | 1770 | 4800 | 18060 |
| 6.8 | 32.7 | 74 | 265 | 678 | 844.41 | 894 | 1000 | 1787.1 | 4825 | 18365 |
| 7 | 33.75 | 77 | 280 | 683 | 845.8 | 895 | 1019 | 1800 | 4996 | 19025 |
| 7.7 | 33.95 | 80 | 285 | 685 | 847.19 | 897 | 1049 | 1816.7 | 4997 | 19888 |
| 7.83 | 35 | 88.99 | 290 | 690 | 848.58 | 898 | 1050 | 1825 | 5000 | 20000 |
| 8 | 36.71 | 91 | 320 | 700 | 849.96 | 899 | 1078 | 1835 | 5096 | 30000 |
| 8.25 | 37 | 95 | 324 | 727 | 851 | 900 | 1108 | 1850 | 5100 | 40000 |
| 9.1 | 38 | 97 | 325 | 760 | 851.35 | 900 | 1137 | 1865 | 5125 | 50000 |
| 9.2 | 39 | 98.25 | 330 | 770 | 852.75 | 902 | 1167 | 1880 | 5225 | 60000 |
| 9.35 | 40 | 100 | 333 | 776 | 854.07 | 903 | 1196 | 1895 | 5565 | 70000 |
| 9.4 | 40 | 110 | 360 | 780 | 855.38 | 905 | 1206 | 2005 | 5706 | 80000 |
| 9.6 | 40.25 | 112 | 380 | 787 | 856.71 | 906 | 1226 | 2007 | 5821 | 90000 |
| 10 | 41 | 114 | 390 | 799 | 858.02 | 907 | 1241 | 2009 | 5894 | 100000 |
| 10.2 | 41.2 | 115 | 400 | 800 | 859.34 | 908 | 1246 | 2013 | 6794 | |
| 10.25 | 42 | 117 | 410 | 802 | 860.66 | 909 | 1255.5 | 2014 | 6916 | |
| 10.55 | 42.25 | 120 | 427 | 804.1 | 861.98 | 910 | 1285.1 | 2015 | 7035 | |

One or more of the selected frequencies, for example as listed in Table 1 above, may be generated in the proximity of the articles to be treated. In one embodiment, a single frequency may be generated, e.g., a frequency listed in Table 1. In another embodiment, multiple frequencies may be generated, e.g., at least two frequencies selected from those listed in Table 1. A typical frequency generator comprises a power source that oscillates or vibrates at one or more selected frequencies. In accordance with certain embodiments of the present invention, commercially available frequency generators may be used in the treatment process. The power or intensity level of the frequency generator may be selected based upon parameters such as the distance between the generator and the articles to be treated, the number of articles to be treated, and the humidity and pressure level of the surrounding atmosphere. In many applications, based upon the power level of a particular frequency generator, parameters such as those noted above may be adjusted in order to produce optimal results.

The vibrations may travel directly from the frequency generator into the articles to be treated through direct contact with the frequency generator, or may pass through a gaseous, liquid and/or solid medium before they reach the article. For example, the medium may be air or any other suitable gaseous medium, water or any other suitable liquid medium, or a combination thereof. In one embodiment, the process is carried out in air at atmospheric pressure. Alternatively, elevated pressures or reduced pressures may be used. The process may be carried out in an enclosure such as a container or a room, or may be carried out in open air. In one embodiment, the medium may be air that is humidified during the process by any known means, such as a humidifier, steam generator, or the like. For example, a humidity of from 50 to 100% may be used, e.g., from 80 or 90% to 100%.

In one embodiment, multiple articles to be treated are positioned in proximity to at least one frequency generator. For example, the distance D between the frequency generator and the articles may be less than 100 feet, typically from 0 to 20 feet, for example, from 0 to 10 or 15 feet. In certain embodiments, the frequency generator may be positioned more than 0.5 or 1 inch away from the frequency generator, for example, more than 0.5 or 1 foot.

Where multiple articles are treated, any suitable number of articles may be selected, e.g., from 2 to 10,000 or more. For example, 10 to 1,000 articles may be treated at one time. The articles may be directly exposed to the medium in which the frequencies are generated, or they may be contained in packaging or other containers such as plastic bags, cardboard boxes, plastic bins, etc.

The duration of the frequency generation may be selected as desired, for example, the articles may be subjected to one or more frequencies for a time of 1 second or less, up to several months or more. For example, exposure times of from 10 seconds to 100 hours may be used, e.g., from 1 minute to 10 hours. When multiple frequencies are used, they may be generated simultaneously, sequentially, or a combination thereof.

In accordance with embodiments of the present invention, selected frequencies from Table 1 are applied to apparel using frequency generators under the following conditions: frequencies generated on apparel in a closed environment for 48 hours; frequencies on apparel in a closed environment for 24 hours; frequencies generated apparel with an alkaline water spray in a closed environment for 24 hours; frequencies generated on apparel with a humidifier in a closed environment for 12 hours; and frequencies generated by on apparel contacted by stone crystals in a closed environment for 24 hours.

In accordance with other embodiments of the invention, textiles are treated as follows: extrusion of a plastic polymer into fabric combined with cotton yarn which is then treated with frequencies of 5,100 Hz and 100,000 Hz; extrusion of a plastic polymer into fabric and provision of buttons which are then treated with frequencies of 9,000 Hz and 10,000 Hz; extrusion of a plastic polymer into fabric and provision of collar stays which are then treated with frequencies of 70,000 Hz and 80,000 Hz; extrusion of a plastic polymer into fabric and a provision of tagless label that are then treated with frequencies of 895 Hz, 896 Hz, 897 Hz, 898 Hz, 899 Hz and 900 Hz; extrusion of a plastic polymer into a polyester yarn that is treated with frequencies of 50,000 Hz and 60,000 Hz; extrusion of a plastic polymer into a polyester yarn combined with cotton and silk which is then treated with frequencies of 50,000 Hz and 60,000 Hz; and extrusion of a plastic polymer into polyester yarn combined with cotton, silk and spandex which is treated with frequencies of 50,000 Hz and 60,000 Hz.

In accordance with further embodiments of the invention, clothing is treated by transmitting frequencies through steel cylinders as follows: steel cylinders are utilized on clothing with frequencies 895 Hz, 896 Hz, 898 Hz, 899 Hz and 900 Hz in a closed environment for 24 hours; steel cylinders are utilized on clothing with frequencies 400 Hz and 800 Hz in and open environment for 3 days; steel cylinders are utilized on clothing with frequencies 69 Hz thru 74 Hz for a 24 hour period; steel cylinders are utilized on clothing with frequencies 831.57 Hz, 832 Hz, 7.83 Hz, 12 Hz and 15 Hz for a 12 hour period; and steel cylinders are utilized on clothing with frequencies 929 Hz thru 931 Hz, 9.6 Hz and 10.25 Hz for a 12 hour period.

In accordance with other embodiments of the invention, clothing is treated by transmitting frequencies through stone crystals as follows: stone crystals are utilized on clothing with frequencies 831.57 Hz, 832 Hz, 7.83 Hz, 12 Hz, 15 Hz, 929 Hz thru 931 Hz, 9.6 Hz, and 10.25 Hz for 1 hour; stone crystals are utilized on apparel with frequencies 831.57 Hz, 832 Hz, 7.83 Hz, 12 Hz, 15 Hz, 929 Hz thru 931 Hz, 9.6 Hz, and 10.25 Hz for 30 minutes; stone crystals are utilized on apparel and alkaline water spray with frequencies 831.57 Hz, 832 Hz, 7.83 Hz, 12 Hz, 15 Hz, 929 Hz thru 931 Hz, 9.6 Hz, and 10.25 Hz for 1 hour; stone crystals are utilized on apparel and a humidifier with alkaline water with frequencies 831.57 Hz, 832 Hz, 7.83 Hz, 12 Hz, 15 Hz, 929 Hz thru 931 Hz, 9.6 Hz, and 10.25 Hz for a 30 minute period; and stone crystals are utilized on apparel with frequencies 831.57 Hz, 832 Hz, 7.83 Hz, 12 Hz, 15 Hz, 929 Hz thru 931 Hz, 9.6 Hz, and 10.25 Hz for a 12 hour period.

In accordance with further embodiments of the invention, textiles are treated by transmitting frequencies through titanium fabric as follows: titanium fabric is utilized on textiles infused with frequencies 160 Hz and 165 Hz for a 12 hour period; titanium fabric is utilized on textiles infused with frequencies 160 Hz and 165 Hz for 24 hours; titanium fabric is utilized on textiles infused with frequencies 160 Hz and 165 Hz for 3 days; titanium fabric is utilized on textiles infused with frequencies 160 Hz and 165 Hz for 30 minutes; titanium fabric is utilized on textiles infused with frequencies 160 Hz and 165 Hz for 1 hour period; titanium fabric is utilized on textiles infused with frequencies 160 Hz and 165 Hz for a 12 hour period; titanium fabric is utilized on textiles infused with frequencies 160 Hz and 165 Hz for 30 minutes; titanium fabric is utilized on textiles and an alkaline water spray infused with frequencies 324 Hz and 325 Hz for 1 hour period; titanium fabric and stone crystals are utilized on apparel infused with frequencies 324 Hz and 325 Hz for 24 hour period; titanium fabric and stone crystals are utilized on apparel infused with frequencies 324 Hz and 325 Hz for a 12 hour period; titanium fabric and stone crystals are utilized on apparel infused with frequencies 324 Hz and 325 Hz for 36 hours; titanium fabric and stone crystals are utilized on apparel infused with frequencies 190 Hz, 191.15 Hz, 192 Hz and 195 Hz for a 24 hour period.

In accordance with further embodiments of the invention, frequencies are transmitted through steel cylinders, stone crystals and titanium fabric as follows: a combination of tuning forks, steel cylinders, stone crystals and titanium are utilized on textiles all treated with frequencies 0.1 Hz, 0.2 Hz, 0.3 Hz 0.4 Hz and 0.5 Hz for a period of 5 days; a combination of tuning forks, steel cylinders, stone crystals, and titanium are utilized on textiles all treated with frequencies 0.1 Hz, 0.2 Hz, 0.3 Hz 0.4 Hz and 0.5 Hz for a period of 48 hours; a combination of tuning forks, steel cylinders, stone crystals and titanium are utilized on textiles all treated with frequencies 0.1 Hz, 0.2 Hz, 0.3 Hz 0.4 Hz and 0.5 Hz for 30 minutes and; a combination of tuning forks, steel cylinders, stone crystals and titanium are utilized on textiles all treated with frequencies 0.1 Hz, 0.2 Hz, 0.3 Hz 0.4 Hz and 0.5 Hz for a 12 hour period.

In accordance with other embodiments of the invention, frequencies are generated with exposure to UV light as follows: ultra violet light is utilized on the clothing using frequencies 23 Hz, 37 Hz, 46 Hz, 57 Hz and 71 Hz for a 1 hour period; ultra violet light is utilized on the clothing with frequencies 23 Hz, 37 Hz, 46 Hz, 57 Hz and 71 Hz for 24 hour period; ultra violet light is utilized on the clothing with frequencies 23 Hz, 37 Hz, 46 Hz, 57 Hz and 71 Hz for a 48 hour period; ultra violet light is utilized on the clothing with frequencies 23 Hz, 37 Hz, 46 Hz, 57 Hz and 71 Hz for a 5 day period; ultra violet light and steel cylinders are utilized on clothing with frequencies 23 Hz, 37 Hz, 46 Hz, 57 Hz and 71 Hz for a 12 hour period; ultra violet light and stone crystals are utilized on clothing with frequencies 23 Hz, 37 Hz, 46 Hz, 57 Hz and 71 Hz for a 1 hour period; and ultra violet and alkaline water spray are utilized on clothing with frequencies 23 Hz, 37 Hz, 46 Hz, 57 Hz and 71 Hz for 30 minutes.

In accordance with further embodiments of the invention, fabrics are treated by transmitting frequencies through liquid containing titanium powder as follows: liquid is sprayed on fabric then embedded with frequencies 23 Hz, 37 Hz, 46 Hz, 57 Hz and 71 Hz for 12 hours; liquid is sprayed on fabric then embedded with frequencies 23 Hz, 37 Hz, 46 Hz, 57 Hz and 71 Hz for 24 hours; liquid is sprayed on fabric then embedded with frequencies 23 Hz, 37 Hz, 46 Hz, 57 Hz and 71 Hz for 6 hours; liquid is sprayed on fabric then embedded with frequencies 23 Hz, 37 Hz, 46 Hz, 57 Hz and 71 Hz for 5 days; and liquid is sprayed on fabric and stone crystals, and steel cylinders are utilized to transmit frequencies from 910 Hz thru 920 Hz for a 12 hour period.

In accordance with other embodiments of the invention, the following frequencies are run for a running time of two hours: frequency of 410 Hz on apparel in an open air environment; frequency of 410 Hz on apparel in an enclosed environment; frequencies of 410 Hz and 650 Hz on apparel in an open environment; frequencies of 410 Hz and 650 Hz on apparel in a humidified and closed environment; frequency of 410 Hz on apparel while applying a light mist of water in an enclosed environment; frequencies of 1,196.48 Hz and 1,226.01 on apparel in an open environment; frequencies of 1,196.48 Hz, 1,226.01 Hz and 1,521.34 Hz on apparel in an open environment; frequencies of 1,196.01 Hz and 1,226.01 Hz on apparel in a closed environment; frequencies of 0.5 Hz, 0.67 Hz, and 1.9 Hz, and 2.1 Hz on apparel in an enclosed environment; and frequencies of 0.5 Hz and 0.67 Hz on apparel in a closed environment.

In accordance with further embodiments of the invention, the following frequencies are run: frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in an open environment for 3 minutes each; frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in an open environment for 6 minutes each; frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in an open environment for 9 minutes each; frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in an open environment for 12 minutes each; frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in a closed environment for 12 minutes each; frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in a closed environment for 12 minutes each; frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in an open environment for 9 minutes each; and frequencies of 2,720 Hz, 1,800 Hz, 776 Hz, 465 Hz, 444 Hz, 200 Hz, 3 Hz, 2.65 Hz, 41.2 Hz, 43.65 Hz, 555 Hz and 999 Hz on apparel in an open environment for 12 minutes each.

The following frequencies are run in an enclosed area using a humidifier with 8 ounces of salt added to the water container of the humidifier: frequencies 1,800 Hz, 880 Hz, 787 Hz, 727 Hz, 650 Hz and 600 Hz for 6 minutes each; frequencies 1,800 Hz, 880 Hz, 787 Hz, 727 Hz, 650 Hz and 600 Hz for 12 minutes each; frequencies 1,800 Hz, 880 Hz, 787 Hz, 727 Hz, 650 Hz and 600 Hz for 18 minutes each; frequencies 1,800 Hz, 880 Hz, 787 Hz, 727 Hz, 650 Hz and 600 Hz for 24 minutes each; and frequencies of 87 Hz, 522 Hz, 88 Hz, 146 Hz, 105 Hz, 428 Hz, 108 Hz, 555 Hz, 109 Hz, 333 Hz and 114 Hz for 3 minutes each, followed by 7.83 Hz for 60 minutes.

Similar runs are conducted in an enclosed area without salt added to the humidifier: frequencies 1,800 Hz, 880 Hz, 787 Hz, 727 Hz, 650 Hz and 600 Hz for 6 minutes each; frequencies 1,800 Hz, 880 Hz, 787 Hz, 727 Hz, 650 Hz and 600 Hz for 12 minutes each; and frequencies 1,800 Hz, 880 Hz, 787 Hz, 727 Hz, 650 Hz and 600 Hz for 18 minutes each.

The following frequencies are run: frequencies 787 Hz, 880 Hz, 3,040 Hz and 10,000 Hz for 30 minutes each; frequencies 787 Hz, 880 Hz, 3,040 Hz and 10,000 Hz for 60 minutes each; and frequencies 787 Hz, 880 Hz, 3,040 Hz and 10,000 Hz for 120 minutes each.

Similar runs are conducted using steel cylinders to transmit the frequencies between the frequency generator and the articles: frequencies 787 Hz, 880 Hz, 3,040 Hz and 10,000 Hz using steel cylinders for 30 minutes each; frequencies 787 Hz, 880 Hz, 3,040 Hz and 10,000 Hz for 60 minutes each using steel cylinders; and frequencies 787 Hz, 880 Hz, 3,040 Hz and 10,000 Hz for 120 minutes each using steel cylinders.

Runs are conducted using crystals to transmit the frequencies between the frequency generator and the articles: frequencies 787 Hz, 880 Hz, 3,040 Hz and 10,000 Hz using crystals, salt, humidifier and water spray for 30 minutes each; frequencies 787 Hz, 880 Hz, 3,040 Hz and 10,000 Hz for 60 minutes each using crystals, salt, humidifier and water spray; and frequencies 787 Hz, 880 Hz, 3,040 Hz and 10,000 Hz for 120 minutes each using crystals, salt, humidifier and water spray.

The following frequencies are run in an open environment and with a humidifier and water spray run for 3 minutes each: frequencies 465 Hz, 444 Hz, 148 Hz, 6.3 Hz, 2.5 Hz, 522 Hz, 428 Hz, 555 Hz, 333 Hz and 999 Hz; and frequencies 465 Hz, 444 Hz, 148 Hz, 6.3 Hz, 2.5 Hz, 522 Hz, 428 Hz, 555 Hz, 333 Hz and 999 Hz with the addition of salt.

The following frequencies are run in a closed environment and with a humidifier, crystals and water spray. Each frequency is run between 3 minutes and 60 minutes each: frequencies 465 Hz, 444 Hz, 148 Hz, 6.3 Hz, 2.5 Hz, 522 Hz, 146 Hz, 428 Hz, 555 Hz, 333 Hz, 999 Hz and 7.83 Hz.

The following frequencies are run in an open environment for 20 minutes, then frequencies 1,800 Hz, 880 Hz and 787 Hz are run for 45 minutes in an open environment using salt and a water spray: frequencies 727 Hz, 650 Hz, 625 Hz, 600 Hz, 125, 95 Hz, 72 Hz, 880 Hz and 3040 Hz.

Frequencies 727 Hz, 650 Hz, 625 Hz, 600 Hz, 125, 95 Hz, 72 Hz, 880 Hz and 3040 Hz are run in a closed environment. Frequencies 1,800 Hz, 880 Hz, 787 Hz, 727 Hz, 650 Hz and 600 Hz are run. Frequencies 1,800 Hz, 880 Hz, 787 Hz, 727 Hz, 650 Hz and 600 Hz are run for 12 minutes in an enclosed area. Frequencies 1,800 Hz, 880 Hz, 787 Hz, 727 Hz, 650 Hz and 600 Hz are run for 18 minutes. Frequencies 1,800 Hz, 880 Hz, 787 Hz, 727 Hz, 650 Hz and 600 Hz are run using titanium strips to conduct frequencies. Frequencies 1,800 Hz, 880 Hz, 787 Hz, 727 Hz, 650 Hz and 600 Hz are run for 12 minutes in an enclosed area using titanium strips to conduct frequencies. Frequencies 1,800 Hz, 880 Hz, 787 Hz, 727 Hz, 650 Hz and 600 Hz are run for 18 minutes using titanium strips to conduct frequencies. Frequencies 1,800 Hz, 880 Hz, 787 Hz, 727 Hz, 650 Hz and 600 Hz are run for 24 minutes using titanium strips to conduct frequencies.

The following frequencies are run in a closed area: frequencies 21 Hz, 19,888 Hz and 20,000 Hz for 18 minutes each; frequencies 21 Hz, 19,888 Hz, and 20,000 Hz for 36 minutes each; and frequencies 21 Hz, 19,888 Hz and 20,000 Hz for 54 minutes. Frequencies 21 Hz, 19,888 Hz and 20,000 Hz are run in an open environment.

The following test was conducted. Four hundred eighty subjects were randomly assigned into user, non user, and control groups. The subject pool was inclusive of both genders and ages 18 to 82 years in physically demanding occupations, e.g., assembly, construction, mechanics, maintenance, landscaping, health care, retail, and warehouse. The physical demands required full range of motion to lift, carry, process and place items using fine motor dexterity. Workers performed job demands seated, standing, or were continuously mobile for a minimum of an 8 hour shift. Chosen workers were placed into one of two groups using random assignment. The subjects were pre-tested to measure grip strength using the Jamar Grip Dynometer and range of motion to establish baselines (degree of range of motion in a 360 degree pattern). Grip strength and range of motion were indexed as output for each individual and grouped to calculate mean ratings.

An enclosed space having dimensions of approximately 6×8×8 feet was initially filled with water vapor from a hot water shower. Cotton tee-shirts were placed within the enclosed area with a commercially available humidifier running. A commercially available frequency generator distributed by CNGI Inc. under the designation Detox Box was positioned in the enclosed area. The following eleven frequencies were generated sequentially from the frequency generator for 3 minutes each: 87 Hz, 522 Hz, 88 Hz, 146 Hz, 105 Hz, 428 Hz, 108 Hz, 555 Hz, 109 Hz, 333 Hz and 114 Hz. A frequency of 7.83 Hz was then generated by the frequency generator for 1 hour. The tee-shirts were then removed from the enclosed area.

The treated shirts were applied to one group and a control applied to the other. The two groups were treated in a similar manner to control for variables such as job demands. Workers in the treatment and control groups stood, sat, walked and pivoted. Pre-test and post-test productivity indices established for each work area (units complete per hour) were the (pre-test) baseline of productivity expectations. At the end of the treated shirt use on a shift, the experiment ended and productivity indexes (post-test) were gathered and compared.

A chi square test for independence was done to determine whether hypothesized results were verified by the experiment. Jamar Grip Strength Normative Data was used to compare subject test scores to compare pre-test scores to established grip strength norms for mutually exclusive categories of age and gender. Correlation coefficients were calculated to determine the relationship between productivity indices and the use of the treated shirts. Analysis was done to calculate the statistical relation between variables to determine if the systematic changes in the value of one variable are accompanied by systematic changes in the other. The relation is represented by a statistic that can vary from −1 (perfect negative correlation) through 0 (on correlation) to +1 (perfect positive correlation). A T-test-procedure was used to assess whether the means of control, pre and post test groups were statistically different from each other. Analysis of variance (ANOVA) was used to determine whether significant differences existed between sample means. The increase for the experimental group was significantly different than the indices in the control group for 20 or 21 hypotheses. All subjects performed better on the grip and range of motion tests when wearing the treated shirt, compared with wearing an untreated shirt, regardless of their job demands. Significant differences and positive correlations were found among all job demand conditions. Under the work conditions, workers produced more units per hour at the quality standard.

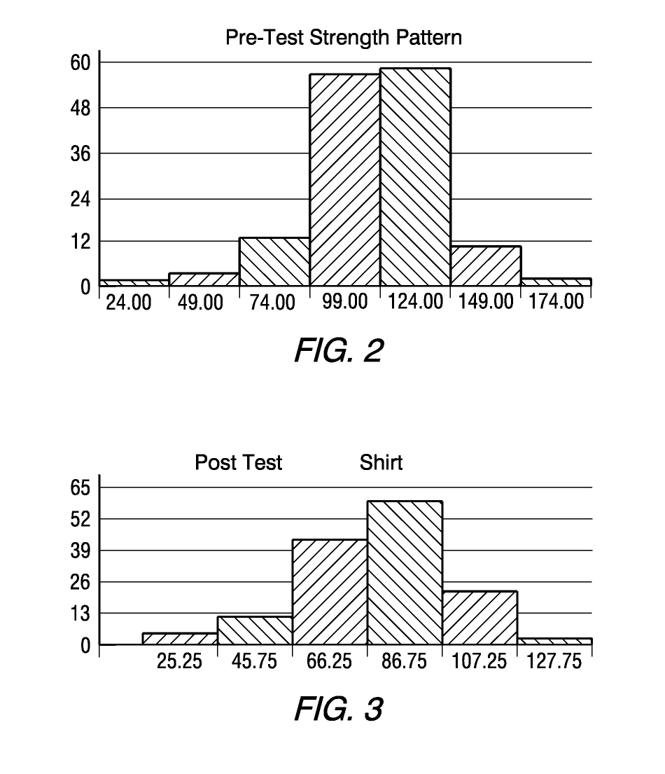

In FIG. 2, the Y axis depicts the highest grip force exhibited for a pre-test group at 60 kg, and the X axis exhibits the number of participants. The highest force exerted by 25 of the pre-text participants was 59 kg or 130 lbs. With a treated shirt draped around the shoulders each participant was asked to exert force for a period of 2 seconds. The dynometer measured the maximum force exerted in pounds. FIG. 3 shows the strength pattern of the post-test. The Y axis depicts the highest force exhibited at 65 kg. The X axis exhibits the number of participants with statistically significant change in strength. The highest force exerted by 20 of the participants was a significant improvement from 59 kg (130 lb) to 63 kg (139 lb) i.e., a 9 lb gain. 127 of the participants show a strength gain of at least 2 pounds.

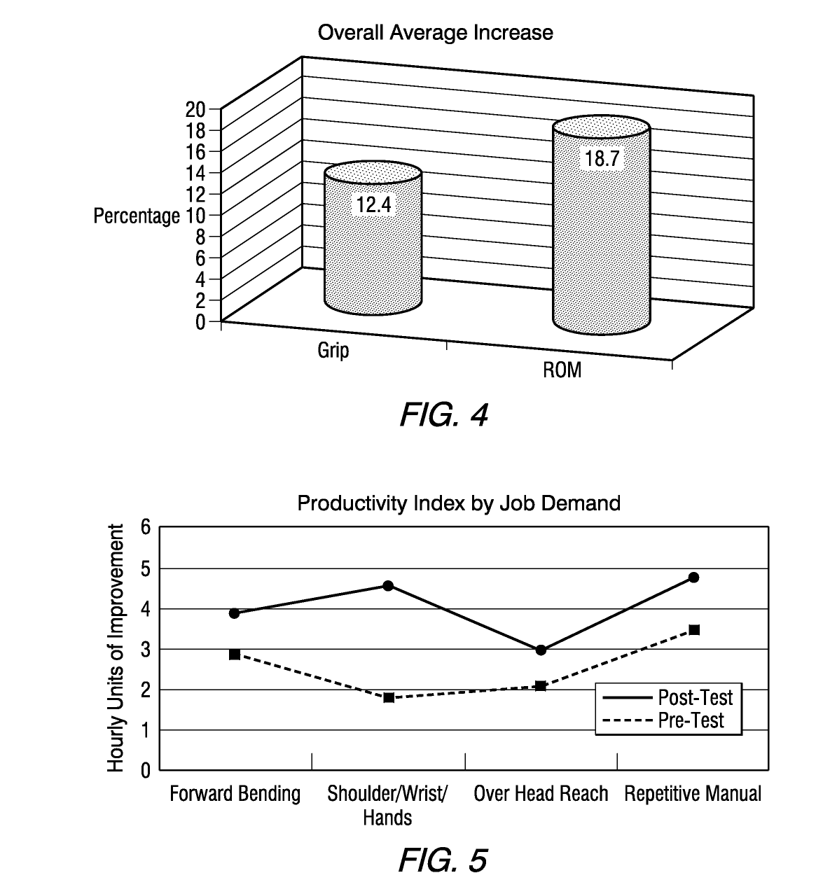

FIG. 4 is a graph illustrating the percentage of improvement in grip and improved range of motion for the entire test population described above.

FIG. 5 is a graph illustrating improved productivity in four categories for the pre-test and post-test population, including improved forward bending, shoulder/wrist/hands, over head reach and repetitive manual activities.

Another test was conducted as follows. The purpose of this study was to assess the application of the treated shirt for even parallel bar gait training. Parallel bars were used to help elders regain their strength, balance, range of motion, and independence. Parallel bars were used as part of the clinical intervention for improving upper body strength that would support balance and gait training. The clinical intervention included combined muscle strength training with stretching, balance training, and aerobic conditioning. These are known methods that demonstrate significant improvements in walking function.

Fifteen (15) consecutive patients referred to physical therapy for mobility problems or recent falls were reviewed for this study. Patients were pre and post evaluated with Walking Index for SCI (WISCI), speed, 5 min walk (walking capacities) and locomotor functional independence measure (L-FIM). Pre evaluation was upon initial referral to physical therapy and post after 30 days of treatment. Participants were 77.2 years old (+/−7.34), whose usual gait velocity was <0.85 m/s (2.78 feet) and walking endurance of <305 m (1,000 feet) in a 5 minute period. Gait training inside even parallel bars was developed around the gait problems and trunk imbalance as noted on initial evaluation of gait affected by, lateral trunk imbalance and toe drop. Physical therapy was for one month at 15 minutes for 5 days a week for 20 sessions. Rehabilitation therapists used parallel bars for coordination exercises that required concise isometric movements of lower and upper body joints and muscles. Patients goals were to develop and improve the range of motion of their joints as well as improve lost muscle strength.

A Wilcoxon signed-rank comparison of the initial and 30 day re-evaluation of the balance and the gait assessment indicated that significant improvement had occurred in when using the treated shirt in the balance scores (Z=−3.20, p=0.001) and the gait scores (Z=−2.82, p=0.005) in this group. The participants wore tee-shirts treated in a similar manner as described above. The participants demonstrated increased mean usual gait velocity (> or =1.0 m/s (3.28 feet) and a mean walking endurance with increased trunk balance (> or =350 m (1,148 feet) in 5 min).

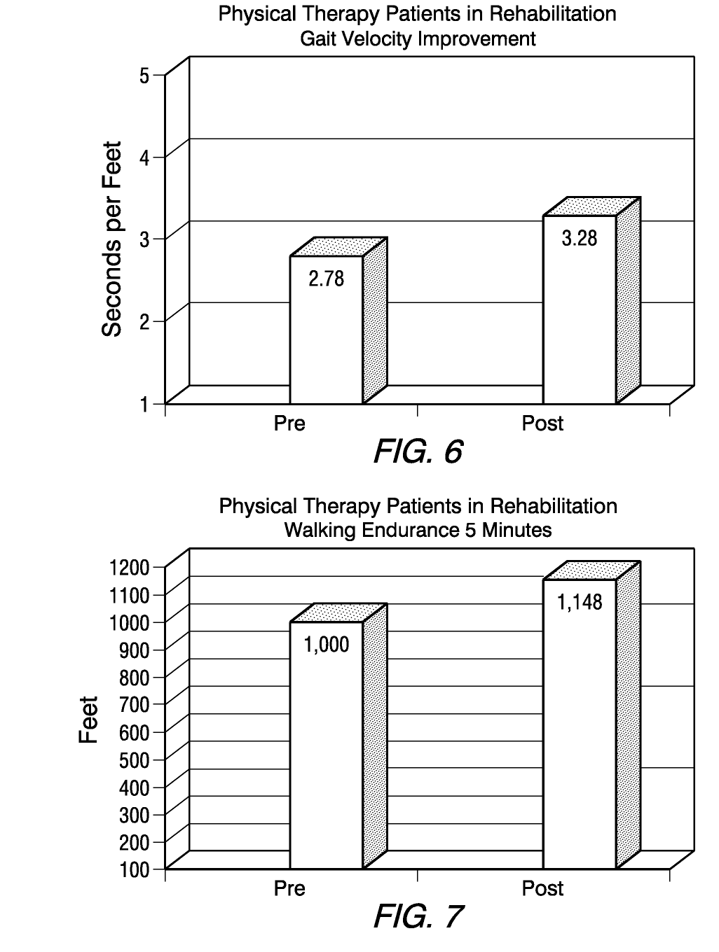

FIG. 6 summarizes the gait velocity improvement. FIG. 7 summarizes the walking endurance improvement. The treated shirt is a contributor to clinical improvements in mobility for frail elders who are at risk for falls. In this study outcome measures of muscle strength improved and positively impacted stability of balance. Walking Index for SCI (WISCI), speed, 5 min walk (walking capacities) and locomotor functional independence measure (L-FIM), as disability measures all showed improvement in walking functions based on rehabilitation activity.

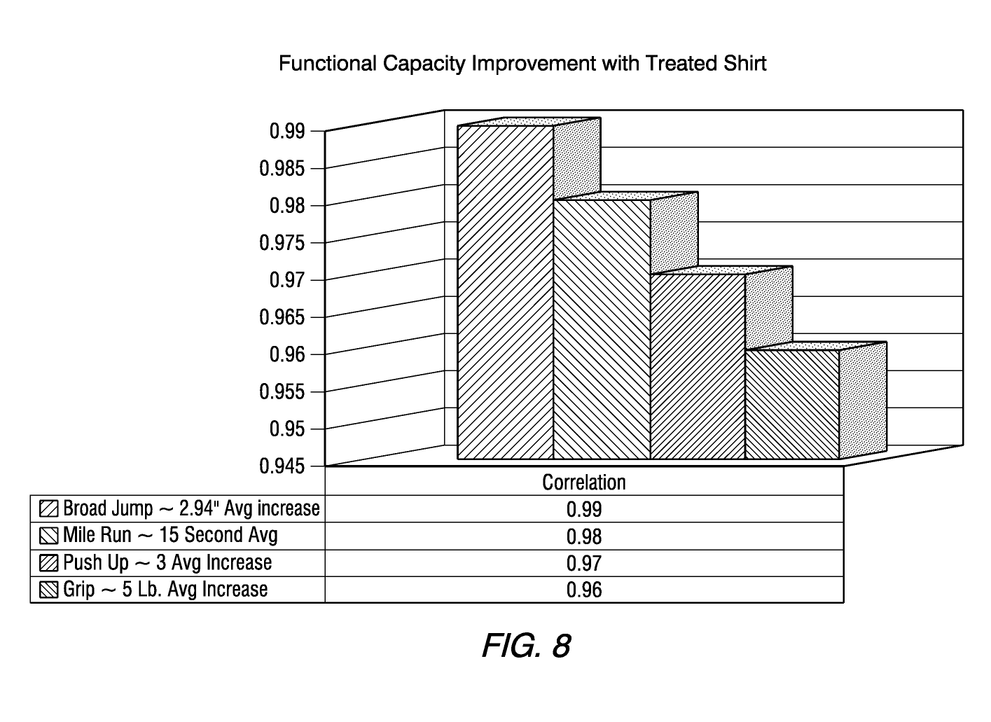

FIG. 8 illustrates functional capacity improvements for a group of test subjects in accordance with an embodiment of the present invention. Thirty female collegiate athletes ranging in age from 18 to 23 were pre-tested using the parameters established by the Jackson Functional Capacity battery to establish baselines. Undergarment tee-shirts were treated as described above, e.g., with frequencies of 87 Hz, 522 Hz, 88 Hz, 146 Hz, 105 Hz, 428 Hz, 108 Hz, 555 Hz, 109 Hz, 333 Hz and 114 Hz for 3 minutes each, followed by a frequency of 7.83 Hz for one hour. Fifteen of the athletes wore the treated undergarment shirts, while the other fifteen athletes wore untreated placebo undergarment shirts. The athletes performed physical activities including broad jump, mile run, pushups, grip strength, vertical leap, and sit and reach exercises. Test results are shown in FIG. 8, indicating significant improvements in broad jump, mile run, pushups and grip strength with good correlations of 0.96 or above. In addition to the improvements shown in FIG. 8, the average vertical leap increased 2.5 inches and the average sit and reach improved 2 inches for the test subjects.

Whereas particular embodiments of this invention have been described above for purposes of illustration, it will be evident to those skilled in the art that numerous variations of the details of the present invention may be made without departing from the invention as defined in the appended claims.

1. A method of treating articles of clothing, textiles and accessories, the method comprising:
positioning the articles in proximity to a frequency generator;
generating at least once selected frequency from the frequency generator;
exposing the articles to the at least one selected frequency for a selected period of time; and
recovering the articles after their exposure to the at least one selected frequency.

2. The method of claim 1, wherein the at least one frequency is within a range of from 0.1 to 100,000 Hz.

3. The method of claim 1, wherein the at least one frequency is within a range of from 1 to 1,000 Hz.

4. The method of claim 1, wherein the at least one frequency is selected from the frequencies listed in Table 1 of the specification.

5. The method of claim 1, wherein from 1 to 20 of the selected frequencies are generated.

6. The method of claim 1, wherein from 2 to 10 of the selected frequencies are generated.

7. The method of claim 1, wherein at least 2 of the selected frequencies are generated in sequence.

8. The method of claim 1, wherein at least 2 of the selected frequencies are generated at the same time.

9. The method of claim 1, wherein the selected period of time is from 1 second to 100 hours.

10. The method of claim 1, wherein the selected period of time is from 1 minute to 10 hours.

11. The method of claim 1, wherein the articles are positioned within 100 feet of the frequency generator.

12. The method of claim 1, wherein the articles are positioned within 10 feet of the frequency generator.

13. The method of claim 1, wherein the articles are positioned from 0.5 inch to 20 feet away from the frequency generator.

14. The method of claim 1, wherein multiple articles are treated at the same time.

15. The method of claim 14, wherein from 10 to 10,000 of the articles are treated at the same time.

16. The method of claim 1, wherein the articles are located in an enclosed space during the treatment process.

17. The method of claim 16, wherein the enclosed space comprises a room of a building.

18. The method of claim 16, wherein the frequency generator is located in the enclosed space.

19. The method of claim 16, wherein the enclosed space is filled with air.

20. The method of claim 1, wherein the treatment process is performed at atmospheric pressure.

21. The method of claim 1, wherein the treatment process is performed in air.

22. The method of claim 21, further comprising humidifying the air.

23. The method of claim 22, wherein the air is humidified to a level of from 80 to 100 percent.

24. The method of claim 22, further comprising adding salt to the humidified air.

25. The method of claim 1, further comprising passing the at least one frequency through a solid material located in proximity to the articles.

26. The method of claim 1, further comprising passing the at least on frequency through a liquid material located in proximity to the articles.

27. The method of claim 1, wherein the articles comprise clothing.

28. The method of claim 27, wherein the clothing comprises shirts, tee shirts, sweatshirts, hoodies, golf shirts, undershirts, vests, uniforms, sports uniforms, work uniforms, industrial uniforms, military uniforms, law enforcement uniforms, firefighter uniforms, EMT uniforms, medical uniforms, scrubs, nurse's uniforms, exercise apparel, sports apparel, recreational apparel, physical therapy apparel, sleepwear, pants, shorts, leggings, underwear, long underwear, undergarments, bras, jackets, gowns, aprons, bibs, outerwear, socks, hats, caps, helmets, shoes, boots, braces and/or sports pads.

29. The method of claim 1, wherein the articles comprise textiles.

30. The method of claim 29, wherein the textiles comprise woven cloth, non-woven cloth, felt, matting, bedding, sheets, blankets, comforters, pillow cases, pillows, carpeting, rugs, window coverings, drapes, window shades, towels and/or washcloths.

31. The method of claim 1, wherein the articles comprise accessories to be worn by people or animals.

32. The method of claim 31, wherein the accessories comprise wrist bands, arm bands, head bands, leg bands, ankle bands, belts, watches, jewelry, bracelets, necklaces, earrings, pendants, pins, eyeglasses, cell phones, smart phones, PDAs, pet collars and/or pet leashes.

33. An article treated by the method of claim 1.
